(19) United States
(12) Patent Application Publication
(10) Pub. No.: US 2004/0179986 A1
(43) Pub. Date: Sep. 16, 2004

(54) Ceramic catalyst for the selective decomposition of N2O and method for making same

(75) Inventors: Wolfgang Burckhardt, Jena (DE); Frank Seifert, Hermsdorf (DE); Manfred Voigt, Giessuebel (DE); Georg Winterstein, Klosterlausnitz (DE)

Correspondence Address: JORDAN AND HAMBURG LLP, 122 EAST 42ND STREET, SUITE 4000, NEW YORK, NY, 10168, US

(73) Assignee: Porzellanwerk Kloster Veilsdorf GmbH, Veilsdorf (DE)

(21) Appl. No.: 10/800,801

(22) Filed: Mar. 15, 2004

Related U.S. Application Data
(62) Division of application No. 09/786,879, filed on Mar. 28, 2001, now abandoned.
Application No. 09/786,879 is a 371 of international application No. PCT/EP99/06392, filed on Aug. 31, 1999.

(30) Foreign Application Priority Data
Sep. 9, 1998 (DE) 19841740.3

(51) Int. Cl. B01D 53/56

(52) U.S. Cl. 423/239.1

(57) ABSTRACT

It is the object of the present invention to provide a catalyst for the selective decomposition of N₂O in a mixture of nitrous gases which is adapted to be applied in a temperature range of from 700° C. to at least 1000° C. without any impairment of the catalyst activities. This object is achieved by a catalyst consisting of a porous ceramic support material and a catalytic active phase, wherein said support material consists of at least 95 percent by weight of one or a plurality of alkaline earth compound/s. The catalyst according this invention is preferably used in the production of nitric acid.

### REFERENCE TO REFERENCE TO RELATED APPLICATION

This is a divisional application of application Ser. No. 09/786,879, filed Mar. 28, 2001.

### BACK GROUND OF THE INVENTION

The invention relates to a ceramic catalyst for the selective decomposition of N₂O (laughing gas) in a mixture of nitrous gases to N₂ and O₂ and method for making the same.

N₂O (laughing gas) is released in greatly differing processes as, for example, in fluidized-bed incineration as well as in processes of the chemical synthesis of nylon, adipic acid and nitric acid. Due to its inertness, it reaches the stratosphere undecomposed where, in the long-term, it accumulates to damage the protecting ozonosphere of the earth. Therefore, for the first time conditions for the global emission reduction of this gas were stipulated at the world environmental conference in Kyoto in 1997. This requires the application of suitable catalysts to treat the waste gas streams.

Apart from various noble metals, ceramics, such as modified zeolites and mixed oxides with perovskite structure, can be utilized as feasible catalyst material. Due to their price advantage compared to noble metals and their better temperature resistance, perovskite combinations are considered as being advantageous. In Catal. Lett. (1995), 34 (3, 4) pp. 373-382 N. Gunasekaran describes, among others, catalytic decomposition of laughing gas by mixed oxides with perovskite structure and perovskite-like structure, wherein La_{0.8}Sr_{0.2}MO_{3-d} (M=Cr, Fe, Mn, Co, Y) and La_{1.8}Sr_{0.2}CuO_{4-d} are considered as advantageous catalyst materials.

Due to energy considerations, the particular object of the previous research work predominantly were catalysts which facilitated decomposition of N₂O as completely as possible within a range of 250° C. to 450° C. Thereby a mixture of an anion defect perovskite of the composition La₁₋ₓCuₓCoO_{3-d}, wherein x=0 . . . 0.5, and of a spinel of the composition Co₃O₄ at a 1:1 mass ratio turned out to be particularly advantageous (DE 197 00 490 A1).

However, the catalysts mentioned herein up to now failed at higher temperatures (800° C.-1200° C.) as the latter are in particular required for the reduction of the N₂O content in process gases in nitric acid production (900° C.). Due to the stipulations of Kyoto mentioned above there is, particularly for the last mentioned process, an increasing demand for catalysts for the reaction mentioned at the beginning of this specification.

The previously known catalysts for the decomposition of N₂O suffer from a nonreversible deactivation at temperatures above 700° C. owing to sintering processes (noble metal catalysts), to a lack of thermal stability of the skeletal structure (zeolite), or to non-reversible reactions between the transitional metal oxides of the active components with the supporting materials of the kind having a high content of Al₂O₃.

Furthermore, a special feature concerning the application in nitric acid production lies in the required selectivity with respect to other oxides of nitrogen, one of which being, indeed, the objective of the synthesis. Such a selection is not required or even undesired with other processes in the waste gas treatment.

Therefore, it is an object of the present invention to provide a catalyst for the selective decomposition of N₂O in a mixture of nitrous gases which is adapted to be applied in a temperature range of from 700° C. to at least 1000° C. without any impairment of the catalyst activities.

The object is realized by the present invention.

### SUMMARY OF THE INVENTION

The substitution of conventional Al₂O₃-containing support materials (for example, alumina or alumino-silicates) by alkaline earth compounds, in particular magnesium oxide, prevents a deactivation of the catalyst by a chemical reaction between the active phase and the support material at temperatures above 700° C. as the same takes place in the prior art, for example, by spinel formation between the oxides of the aluminum and of the cobalt. Moreover, different alkaline earth oxides themselves exhibit a certain catalytic activity in dependence on their pore structure when decomposing the laughing-gas.

The production of the alkaline earth oxide is, for example, carried out by the calcination of a salt, preferably of the carbonate, whereby the calcination temperature depends on the stability of the carbonate of the respective element, on the desired granularity of the alkaline earth oxide, and on a later application temperature of the catalyst.

The oxides and the mixed oxides of the catalytically active component are preferably produced wet chemically by mixed precipitation, drying and thermal decomposition of the dried products. Alternative methods are the production by means of solid-state reaction at high temperatures, pyrolytic processes as well as all other known methods of the powder production.

The active components can be added prior or after the calcination of the support material in the form of precursor compounds (salts), oxides or mixed oxides. In addition to the mechanical mixing of both components, there are different methods available for impregnating the support surface with the active component as well as the deposition by precipitation upon the calcined support material with a subsequent fixing by drying and thermal treatment.

The mentioned mixtures are plasticized and homogenized under addition of suitable plasticizing aids and water, as known in ceramic manufacturing, in order to produce shaped catalyst elements. It is feasible to add binding agents for increasing the strength, such as silica sol, inorganic polymers in, for example, the form of magnesium phosphates, aluminum phosphates, and boron phosphates, respectively, or bonding clays, whereby the part of the same has to be kept as low as possible, provided that no alkaline earth compounds are concerned. Said binding agents for increasing the strength can be homogeneously added prior or after the calcination of the alkaline earth salt. The completion is carried out according to the known ceramic methods, such as granulating or extrusion. By a subsequent release and sintering catalyst elements can be produced in the form of granular material, bulk material, or honeycomb bodies.

The effectiveness of the catalysts of the invention is subsequently disclosed by virtue of three embodiments having different proportions of the catalytically active phase. Furthermore, there are added six examples of additions for increasing strength according to the invention.

### BRIEF DESCRIPTION OF THE DRAWINGS

In the drawings:

FIG. 1 is a plot of laughing gas decomposition by a catalyst of the invention with a 0.1 per cent by weight catalytic active phase (active component) as a function of temperature (Example 1);

FIG. 2 is a plot of the selectivity of the catalyst of FIG. 1 towards NOₓ, also as a function of the temperature;

FIG. 3 is a plot of laughing gas decomposition by a catalyst of the invention having a 1.5 per cent by weight catalytic active phase (active component) as a function of the temperature (Example 2);

FIG. 4 is a plot of the selectivity of the catalyst of FIG. 3 towards NOₓ also as a function of the temperature;

FIG. 5 is a plot of laughing gas decomposition by a catalyst of the invention having a 5.0 per cent by weight catalytic active phase (active component) as a function of the temperature (Example 3);

FIG. 6 is a plot of the selectivity of the catalyst of FIG. 5 towards NOₓ also as a function of the temperature.

### EXAMPLES 1-3

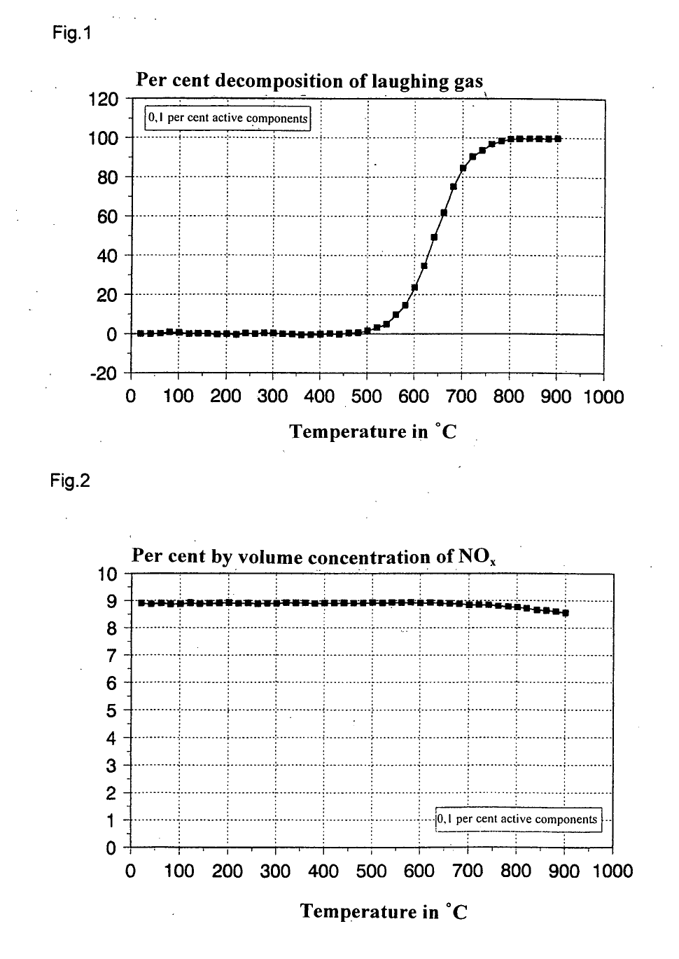

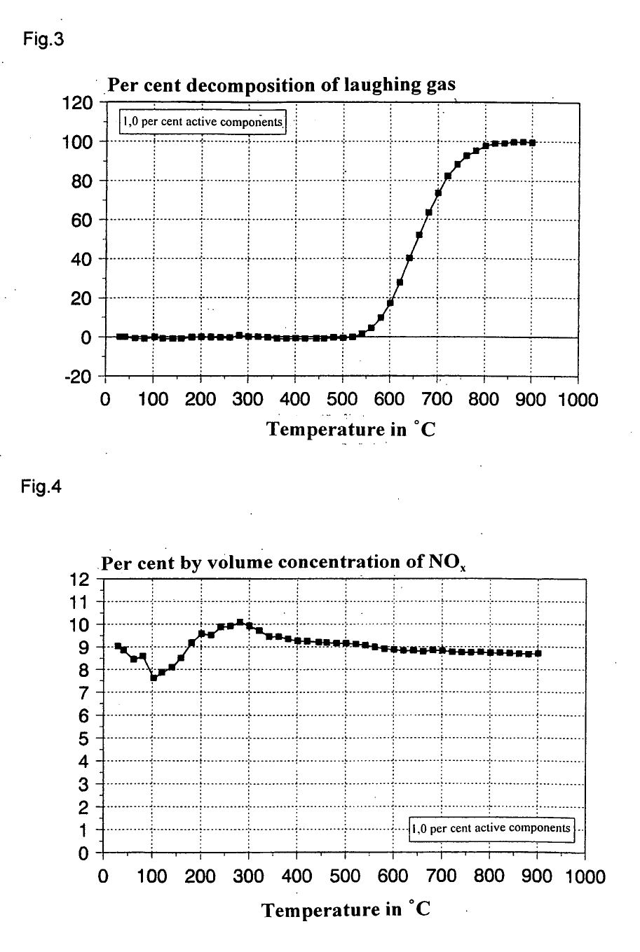

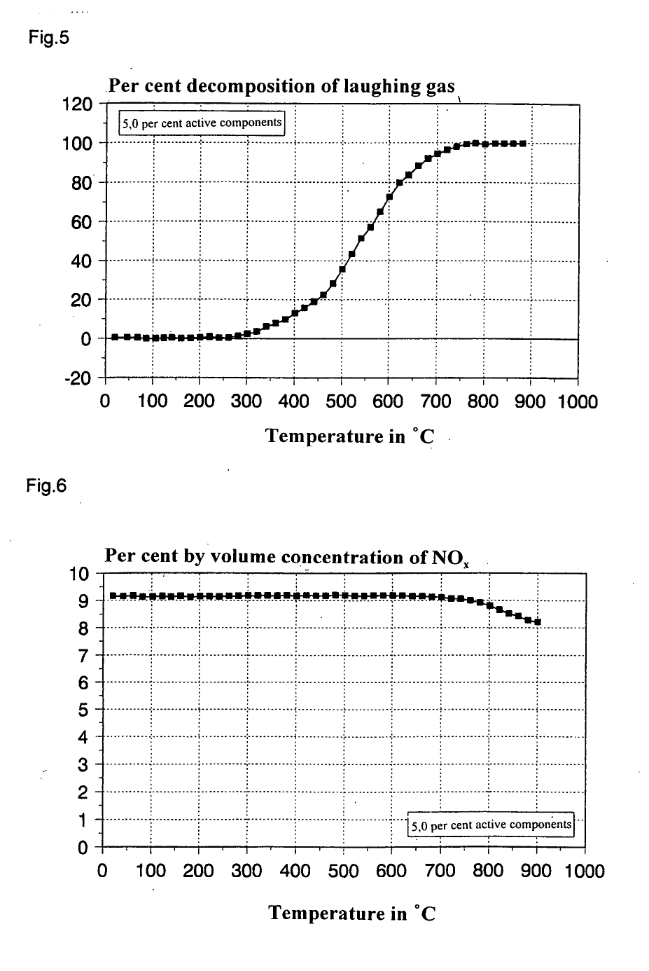

A catalyst of the invention in the form of a granular material was tested by means of a test gas simulating the process gas of the nitric acid production, said test gas being constituted of 2000 vol.-ppm N₂O; 9.0 vol.-% NO, 6.0 Vol. % O₂; 0.14 vol.-% H₂O; remainder N₂. In the case of Examples 1 and 2, the active phase consists of 0.1 weight % and 0.5 weight percent, respectively, of a heavy metal catalyst with the main constituents Mn, Fe, Cr, and Co. In the case of Example 3, the active phase consists 5.0 weight percent of a lanthanum-strontium-manganese-cobalt perovskite. At a space velocity of 10.000 h⁻¹ and at a temperature of 800° C., one respective 100% catalytic conversion of the N₂O (FIGS. 1, 3, 5) was carried out with each of the catalysts. The NOₓ contained in the gas stream is scarcely reduced. It was surprisingly found that a complete conversion of the laughing-gas was virtually obtained independently of the concentration of the active component already at the low content of 0.1 per cent by weight of Example 1 at the 800° C. mentioned. A higher content of the active phase, as in Examples 2 and 3, only results in an earlier starting of the reaction without the same being completed at lower temperatures.

Since the alkaline earth compounds, being essential for the invention, are not adapted to form a sufficiently stable ceramic by themselves, it depends on employing such binding agent phases in the course of producing the ceramic catalysts of the invention which exhibit a sufficient strength in the burned state, provided the porous ceramic support material is comprised of at least 95 per cent by weight of alkaline earth compounds. To this end, there may be added a SiO₂-sol as oxide-sol which contains 5 to 25 weight %, preferably 10 to 15 weight % SiO₂ or there may be added magnesium phosphates, aluminum phosphate and/or boron phosphate as inorganic polymers in a range of from 3 to 20 weight %, preferably 8 to 15 weight % related to the entire mass of the support material, maintaining the condition, however, that the support material is comprised of at least 95 weight % of one or more alkaline earth compounds or there may be added aluminum hydroxide and/or polymeric magnesium silicates as inorganic polymers in a range of from 3 to 20 weight %, preferably 8 to 15 weight % related to the entire mass of the support material, maintaining the condition, however, that the support material is comprised of at least 95% of one or more alkaline earth compounds.

### EXAMPLE 4

15 percent by weight of a SiO₂-sol with a SiO₂ content of 13% are added to the alkaline earth compounds for the support material. After burning as usual in ceramic technology the SiO₂ part of the ceramic support material exhibiting good strength values amounts to 1.95 per cent by weight.

### EXAMPLE 5

14 percent by weight of a magnesium phosphate containing, among others, 6% MgO and 37% P₂O₅, are added to the alkaline earth compounds of the support material. After burning, the MgO part of a ceramic support material constituted substantially of CaO amounts to 0.84 per cent by weight and, if the support material substantially consists of MgO, instead, the proportion thereof is increased by the same percentage.

### EXAMPLE 6

12 percent by weight of a magnesium phosphate containing, among others, 8% of Al₂O₃ and 35% P₂O₅ are added to the alkaline earth compounds of the support material. After burning, the Al₂O₃ part of the ceramic support material amounts to 0.96 percent by weight.

### EXAMPLE 7

8 percent by weight of a boron phosphate containing, among others, 36% of B₂O₃ and 57% P₂O₅ are added to the alkaline earth compounds of the support material. After burning, the B₂O₃ part of the ceramic support material amounts to 2.9 percent by weight.

### EXAMPLE 8

5.5 percent by weight of an aluminum oxide precursor consisting of 85% of Al₂O₃ and 15% H₂O are added to the alkaline earth compounds of the support material. After burning, the Al₂O₃ part of the ceramic support material amounts to 4.7 percent by weight.

### EXAMPLE 9

5 percent by weight of a polymeric magnesium silicate, containing, among others, 23.7 percent by weight MgO and 57 percent by weight SiO₂ are added to the alkaline earth compounds of the support material. After burning, the MgO part of a ceramic support material substantially consisting of CaO amounts to 1.2 percent by weight MgO as well as 2.85 per cent by weight SiO₂ and, if the support material substantially consists of MgO, instead, the proportion thereof is increased by the aforementioned percentage of MgO.

What is claimed is:

1. Process for the selective decomposition of N₂O to N₂ and O₂, in a mixture of nitrous gases, comprising contacting said nitrous gases with a catalyst which consists of a porous ceramic support material and a catalytically active phase, said support material comprising at least 95 per cent by weight of at least one alkaline earth compound.

2. Process according to claim 1, wherein said at least one alkaline earth compound comprises at least one of magnesium oxide and calcium oxide.

3. Process according to claim 1 or 2, wherein said catalyst further comprises at least one stability improving additive selected from the group consisting of oxide sols and inorganic polymers.

4. Process according to claim 1 or 2, wherein said catalytically active phase consists of at least one member selected from the group consisting of oxides and mixed oxides of the elements Cr, Mn, Fe, Co, Ni, Cu, Zn, Ga, In, Ag, Ti, Y, Zr, La, Ca, Sr and Ba.

5. Process according to claim 1 or 2, wherein said catalytically active phase comprises 0.1% by weight to 50% by weight of the catalyst.

6. Process according to claim 1 or 2, wherein said catalytically active phase comprises 0.1% by weight to 5% of the catalyst.

7. Process according to claim 1 or 2 wherein said catalyst is in the form of a powder mixture.

8. Process according to claim 1 or 2, wherein said catalyst comprises a layer of the catalytically active phase on the surface of the porous ceramic support material.

9. Process according to claim 1 or 2, wherein said catalytically active phase of the catalyst is dispersed in the porous catalyst support.

10. Process according to claim 5, wherein the oxides and the mixed oxides of the catalytically active phase are produced wet chemically by mixed precipitation of corresponding carbonates, citrates, hydroxides and/or oxalates and subsequent drying and thermal decomposition of the precipitation product.

11. Process according to claim 4, wherein the method of producing said catalyst comprises the step of adding to the support material at least one inorganic polymer in the form of magnesium phosphates, aluminum phosphates and/or boron phosphates in a range of from 3% by weight to 20% by weight based on the weight of the support material.

12. Process according to claim 4, wherein the method of producing said catalyst comprises the step of adding to the support material at least one inorganic polymer in the form of aluminum hydroxide and/or polymeric magnesium silicates in a range of from 3% by weight to 20% by weight based on the weight of the support material.

13. Process according to claim 5, wherein said elements are La, Cr, Mn, Fe, Co, Ni and Cu.

14. Process according to claim 13, wherein said element is Co.

15. Process according to claim 1 or 2, wherein said catalytically active phase comprises 5% by weight to 20% by weight of the catalyst.

16. Process of claim 11, wherein the amount of the at least one inorganic polymer added to the support material is 8% by weight to 15% by weight based on the weight of the support material.

17. Process of claim 11, wherein the amount of the at least one inorganic polymer added to the support material is 8% by weight to 15% by weight based on the weight of the support material.
